(19) United States
(12) Patent Application Publication
(10) Pub. No.: US 2025/0044153 A1
(43) Pub. Date: Feb. 6, 2025

(54) METHOD OF ANALYSING A SPECTRAL PEAK USING A NEURAL NETWORK

(71) Applicant: Thermo Fisher Scientific (Bremen) GmbH, Bremen (DE)

(72) Inventors: Antonella Guzzonato, Bremen (DE); Ningning Pan, Bremen (DE); Mischa Jahn, Bremen (DE)

(73) Assignee: Thermo Fisher Scientific (Bremen) GmbH, Bremen (DE)

(21) Appl. No.: 18/718,540

(22) PCT Filed: Dec. 14, 2022
(86) PCT No.: PCT/EP2022/085984

§ 371 Date: Jun. 11, 2024

(30) Foreign Application Priority Data
Dec. 17, 2021 (GB) 2118411.4

(51) Int. Cl. G01J 3/443; G01J 3/28

(52) U.S. Cl. CPC G01J 3/443; G01J 3/2803; G01J 2003/2813; G01J 2003/2843

(57) ABSTRACT

A method of operating a spectrometer controller is provided. The method comprises obtaining an interfered peak using a detector of a spectrometer, wherein the interfered peak is produced by a plurality of spectral emissions of different wavelengths, each of the plurality of spectral emissions in the interfered peak incident on the detector at an associated detector location. For one or more of the spectral emissions of the interfered peak, an associated curve is generated using a neural network, wherein the neural network is trained to output data indicative of a shape of the associated curve based on data representative of the associated detector location. For one or more of the spectral emissions of the interfered peak, the associated curve is output.

### FIELD OF THE DISCLOSURE

The present disclosure relates to methods of analysing spectral peaks. In particular, the present disclosure relates to methods of analysing spectral peaks generated using a spectrometer.

### BACKGROUND

Spectrometry is an analytical technique for analysing a sample.

As such, a spectrometer may generate a plurality of spectral peaks from a sample. Part of the process of analysing the plurality of spectral peaks involves the identification of spectral peaks from the measurement data. The identification process typically involves fitting a curve to the measurement data in order to identify a peak location (and associated wavelength), and a peak intensity. The peak wavelength and intensity can be used to determine the element(s) present in the sample and the relative quantity of each element.

The process of fitting the curves to the measurement data typically involves an assumption about the peak shape. For example, “Quantification and deconvolution of asymmetric LC-MS peaks using the bi-Gaussian mixture model and statistical model selection”, Yu T., and Peng H., BMC Bioinformatics, 12 Nov. 2010 discusses a method for quantifying asymmetric chromatographic peaks measured using a Liquid Chromatography-Mass Spectrometry system. The method discussed uses a bi-Gaussian peak model to fit curves to the measurement data.

In spectrometry, spectral peaks generated from a sample may include two or more spectral peaks which have a similar wavelength. Consequently, when the spectral peaks are imaged on the detector, spectral peaks of a similar wavelength may overlap. Overlapping spectral peaks can result in an erroneous identification as a result of the interference between the overlapping spectral peaks.

When overlapping spectral peaks occur, a user may elect not to use the overlapping spectral peaks for further analysis. Abandoning the analysis of overlapping spectral peaks increases the time taken to analyse a sample, requires user input to review the overlapping peaks, and fails to take advantage of all of the available spectral data.

Alternatively, an inter-element correction algorithm can be applied to resolve the overlapping peaks, such as those described in “Interelement corrections in spectrochemistry”, Volker, T.; Schatzlein, D; and Mercuro, D., Spectroscopy, v. 21, n. 7, p. 32, July 2006. Performing inter-element correction may not be possible depending on the measurement circumstances, requires additional user effort, and may not always yield a correct result.

Accordingly, the present disclosure seeks to provide a method for analysing a spectral peak that tackles at least one of the problems associated with prior art methods, or at least, provide a commercially useful alternative thereto.

### SUMMARY

According to a first aspect, a method of operating a spectrometer controller is provided.

The method comprises:
obtaining an interfered peak using a detector of a spectrometer, wherein the interfered peak is produced by a plurality of spectral emissions of different wavelengths, each of the plurality of spectral emissions in the interfered peak incident on the detector at an associated detector location;
for one or more of the spectral emissions of the interfered peak, generating an associated curve using a neural network, wherein the neural network is trained to output data indicative of a shape of the associated curve based on data representative of the associated detector location; and
for one or more of the spectral emissions of the interfered peak, outputting the associated curve.

According to the method of the first aspect, an interfered peak obtained by the spectrometer controller may be processed. In particular, the method of the first aspect processes interfered peaks which are produced by at least two spectral emissions of different wavelengths. The method of the first aspect provides a method for generating a curve set for the interfered peak in order to identify the underlying spectral emissions forming the interfered peak. As such, the method of the first aspect allows the different spectral emissions from interfered peaks to be characterised by generated curves (whose parameters include the peak intensity and peak wavelength of each of the spectral emissions) such that the information from the interfered peaks can be used for further analysis. That is to say, the method of the first aspect allows a user to utilize a greater proportion of the sample spectrum using a peak identification process that is computationally efficient and increases throughput by requiring less manual intervention by users.

In order to process the interfered peak, the method of the first aspect generates a curve set for the interfered peak. The present invention realises that the contribution to the overall shape of the interfered peak from each different spectral emission depends, at least in part, on the optical aberrations introduced by the spectrometer as a result of the detector and any associated optics. The degree of optical aberration is detector location dependent (the detector location having an associated wavelength). The location-variable nature of the optical aberration makes it challenging to accurately fit curves to an interfered peak using any conventional techniques in which it is assumed that each spectral emission across the detector has the same peak shape, and thus that that peak shapes are position-independent; any such assumption leads to inaccurate analysis due to the nature of the optical aberrations introduced by the spectrometer.

By accounting for the optical aberration of the spectrometer, the peak shape associated with each spectral emission may be more accurately generated. Accordingly, the contribution of each spectral emission to the interfered peak may be more accurately accounted for. For example, the area under the interfered peak may be more accurately attributed to one or more of the spectral emissions, thereby improving the accuracy of any subsequent analytical techniques based on the area under the associated peak.

In order to accurately generate a curve set for an interfered peak, the method of the first aspect provides a neural network technique to output a peak shape for each spectral emission forming the interfered peak. In some embodiments, the curve set associated with an interfered peak is the peak shape set output by the neural network technique, while in other embodiments, the peak shape set output by the neural network technique may be further modified in order to generate a curve set that includes a plurality of adjusted curves associated with the interfered peak. Each curve in a curve set associated with an interfered peak may have an associated peak wavelength and an associated peak intensity. The curves in the curve set can then be output by the method for further processing of the underlying spectral emissions forming the interfered peak.

In some embodiments, the neural network technique includes deploying a trained neural network to output an encoded representation of a peak shape associated with a spectral emission of an interfered peak based on data representative of the detector location of a spectral emission (and, in some embodiments, data representative of the peak intensity of the respective spectral emission). In some embodiments, the neural network technique may include applying a decoder to the output of the neural network to decode the encoded representation of each peak shape in order to generate a peak shape for each spectral emission associated with the interfered peak.

In some embodiments, the neural network is trained to predict a peak shape for each spectral emission based on a training data set including a plurality of training peaks. In some embodiments, each training peak is a single spectral emission associated with a different detector location, obtained by a spectrometer. That is to say, the training peaks have different wavelengths such that they are characterise spectral peaks that are distributed across the detector in a plurality of different detector locations. In some embodiments, at least some of the training data set is obtained by the same spectrometer used to generate the interfered peak. As such, the neural network may be trained using measurement data from the same spectrometer that generates the sample peaks to be processed, and thus the optical aberrations present in the sample spectra to be processed will also be present in the training data used to train the neural network. Accordingly, as the training data set may reflect the optical aberrations introduced by the spectrometer, the neural network may be trained to output peak shapes for the spectral emissions of an interfered peak which more accurately characterize the interfered peak than conventional methods.

In some embodiments, other spectrometers having the same type of detector may be used to generate one or more training peaks forming part of the training data set. That is to say, the other spectrometers may have a similar (preferably identical) detector and optical arrangement. For example, spectrometers of a similar model having generally similar components (detector, optical arrangement etc.) may have similar optical aberrations such that training peaks produced by one spectrometer may be used as part of a training data set for other spectrometers of a similar model. As such, the training data set may comprise training peaks from a plurality of spectrometers.

In some embodiments, the plurality of training peaks in the training data set is obtained by measurement of one or more calibration samples using the spectrometer. A calibration sample may be provided having a known composition, such that the resulting calibration spectrum has a plurality of known single-peak spectral sources (i.e., non-interfered peaks).

In some embodiments, the plurality of known single peaks may be distributed across the detector in order to allow the optical aberration of the spectrometer to be accurately characterised by the training peaks.

In some embodiments, the calibration sample comprises a single-element solution. In some embodiments, the single element solution comprises a transition metal. In particular, where the calibration sample is used to calibrate an optical emission spectrometer, transition metal spectra comprise a larger number of spectral emissions across a broad range of wavelengths. As such, calibration samples comprising a single-element transition metal solution are well-suited to providing a plurality of training peaks for a neural network used in the method of the first aspect.

In some embodiments, the spectrometer is a topological spectrometer. That is to say, the spectrometer is configured to produce a signal for which a feature-level representation of its shape (i.e. a function approximation) is topologically associated with the detector of the topological spectrometer. For example, a topological spectrometer may a detector, for example an array detector, which is configured to detect a signal which is topologically distributed across the detector. Examples of a topological spectrometer include an atomic emission spectrometer, an optical emission spectrometer, an x-ray fluorescence spectrometry system, and a laser-induced breakdown spectrometry system.

In some embodiments, the spectrometer comprises an echelle grating and a two-dimensional detector (i.e. a two-dimensional array detector), wherein the spectrometer generates the sample spectrum using the echelle grating to diffract light on to the two-dimensional detector. Such spectrometers distribute sample peaks across a two-dimensional detector as a plurality of orders. That is to say, the sample peaks are spatially distributed across the detector. Accordingly, the effect of optical aberration introduced by the spectrometer on the peak shape of spectral emissions and their associated wavelength may be highly non-linear. As such, methods of the first aspect are particularly well-suited to characterising the optical aberrations introduced by an echelle grating and associated optical elements.

In some embodiments, the method further comprises identifying a sample peak as an interfered peak. The step of identifying the sample peak as an interfered peak may be performed prior to spectrometer controller obtaining the interfered peak for the purpose of performing the method of the first aspect.

In some embodiments, identifying the sample peak as an interfered peak comprises calculating the first derivative of the sample peak, wherein the sample peak is determined to be an interfered peak when the number of zero-crossings of the first derivative of the sample peak is greater than one. As such, the method of the first aspect may identify interfered peaks for further analysis using an efficient analytical technique. In other embodiments, a user may specify specific peaks, or an area of a sample spectrum, as an interfered peak in order to be further processed in accordance with the first aspect.

In some embodiments, the associated detector location of each spectral emission in the interfered peak is determined based on the zero-crossings of the first derivative of the sample peak. As such, the process of determining whether a sample peak is an interfered peak may also be used to provide a starting point for the prediction of the curves forming the interfered peak. The peak wavelengths and peak intensities determined initially may then be further adjusted by the method of the first aspect using the neural network technique.

In some embodiments, the peak intensities determined by the controller may be provided to the neural network for the generating the associated curves. In some embodiments, the neural network uses the peak intensities to output one or more curves associated with the respective spectral emissions of the interfered peak. In some embodiments, peak intensity may not be provided to the neural network as an input, but may instead be applied to the output of the neural network (e.g., by scaling) to ensure that the curves in the resulting curve set have the correct peak intensities.

In some embodiments, the detector of the spectrometer is an array detector. By array detector, it is understood that the detector comprises a plurality of detecting elements (e.g. pixels) arranged as an array. The array may be a one-dimensional array or a two-dimensional array.

In some embodiments, the spectrometer is an atomic emission spectrometer, and the spectrometer controller is an atomic emission spectrometer controller. In particular, the spectrometer may be an optical emission spectrometer, and the spectrometer controller may be an optical emission spectrometer controller. The method of the first aspect may also be applied to other types of spectrometers (and associated controllers) such as an x-ray fluorescence spectrometry system, a laser-induced breakdown spectrometry system.

In some embodiments, a curve is output for each of the spectral emissions in the interfered peak. Each curve output may be used to directly predict the peak shape of the associated spectral emission.

In some embodiments, a comparison curve associated with a spectral emission is obtained by subtracting the curves for the other spectral emissions of the interfered peak from the interfered peak. It will be appreciated that the comparison curve may also indicate the peak shape of the associated spectral emission.

Ideally, the peak shape predicted by a comparison curve for a spectral emission should closely match the peak shape for the spectral emission directly predicted by the neural network. This relationship between the comparison curve and the directly predicted curve can be used as a cross check. Thus, in some embodiments, the method further comprises: performing a confidence analysis comprising comparing the comparison curve of the spectral emission to a curve output by the spectrometer controller for the same spectral emission, and determining a confidence level for the curve output by the spectrometer controller based on the comparison. The confidence level may be a numerical value (e.g. mean squared error), or one of a few discrete flags (e.g. pass/fail; green/amber/red) based on one or more threshold values for the difference between the two curves.

According to a second aspect of the disclosure, a spectrometer controller for a spectrometer is provided. The spectrometer controller is configured to:
obtain an interfered peak using a detector of a spectrometer, wherein the interfered peak is produced by a plurality of spectral emissions of different wavelengths, each of the plurality of spectral emissions in the interfered peak incident on the detector at an associated detector location;
for one or more of the spectral emissions of the interfered peak, generate an associated curve using a neural network, wherein the neural network is trained to output data indicative of a shape of the associated curve based on data representative of the associated detector location; and
for one or more of the spectral emissions of the interfered peak, output the associated curve.

As such, the spectrometer controller of the second aspect may be configured to perform the method of the first aspect. Accordingly, the spectrometer controller of the second aspect may incorporate any of the optional features, and associated advantages, of the first aspect.

The spectrometer controller of the second aspect may be provided using a spectrometer controller of a spectrometry system. In some embodiments, the spectrometer controller may comprise a processor (e.g., a microprocessor) or the like.

According to a third aspect of the disclosure, a spectrometry system is provided. The spectrometry system comprises a spectrometer and a spectrometer controller. The spectrometer comprises a detector. The spectrometer is configured to generate a sample spectrum from a sample using the detector. The spectrometer controller is configured to process the sample spectrum, wherein the controller further is configured to:
obtain an interfered peak from the sample spectrum using the detector of the spectrometer, wherein the interfered peak is produced by a plurality of spectral emissions of different wavelengths, each of the plurality of spectral emissions in the interfered peak incident on the detector at an associated detector location;
for one or more of the spectral emissions of the interfered peak, generate an associated curve using a neural network, wherein the neural network is trained to output data indicative of a shape of the associated curve based on data representative of the associated detector location; and
for one or more of the spectral emissions of the interfered peak, output the associated curve.

As such, the spectrometry system may comprise the spectrometer controller of the second aspect. The spectrometry system may be configured to perform the method of the first aspect. As such, it will be appreciated that the spectrometry system of the third aspect may incorporate any of the optional features, and associated advantages, of the first or second aspects discussed above.

In some embodiments, the spectrometer comprises a plasma source.

According to a fourth aspect of the disclosure, a computer program is provided. The computer program comprises instructions configured to, upon execution by one or more processing devices of the controller, cause the controller of the second aspect, or the spectrometry system of the third aspect, to execute the steps of the first aspect.

According to a fifth aspect of the disclosure, a computer-readable storage medium is provided, the computer-readable storage medium having stored thereon the computer program of the fourth aspect.

### BRIEF DESCRIPTION OF THE FIGURES

The invention may be put into practice in a number of ways and specific embodiments will now be described by way of example only and with reference to the figures in which:

FIG. 1 shows a schematic diagram of a spectrometry system;

FIG. 2 illustrates a detector imaging a spectrum generated by an echelle grating;

FIG. 3 shows a block diagram of a method of analysing a spectral peak of a sample spectrum according to an embodiment of the disclosure;

FIG. 4 shows an example of an interfered peak resulting from two spectral emissions of different wavelengths;

FIG. 5 shows an image recorded by a detector including a plurality of training peaks;

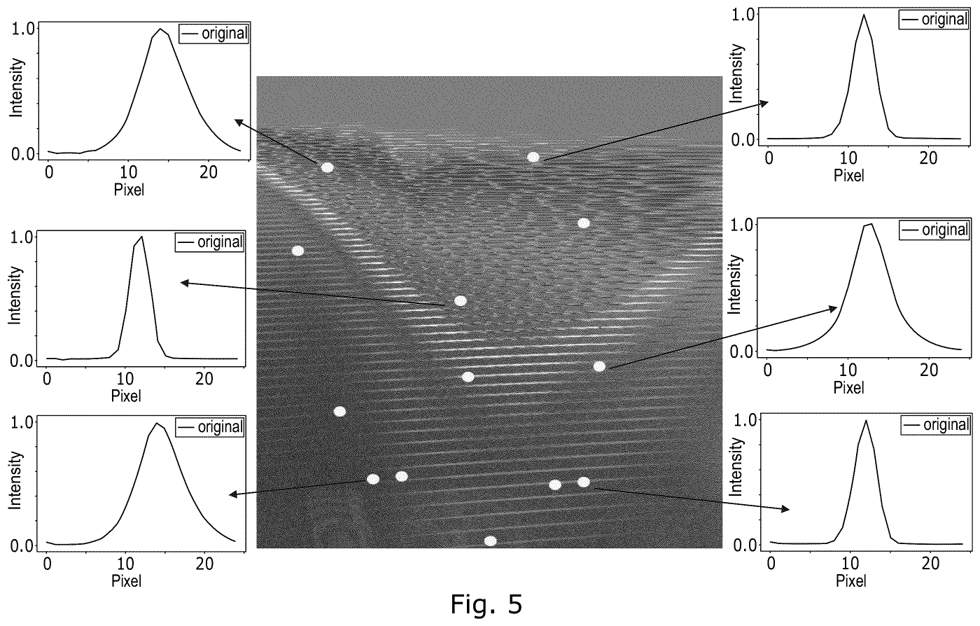

FIG. 6 shows a schematic diagram of an autoencoder used to encode spectral peaks;

FIG. 7 shows a block diagram of a method of fitting a plurality of curves to an interfered peak;

FIG. 8 shows a further example of an interfered peak resulting from at least three spectral emissions of different wavelengths;

FIG. 9 shows a graph of three curves generated from the interfered peak of FIG. 8;

FIG. 10 shows a graph of a curve generated for the central spectral emission of FIG. 8 and an associated baseline correction;

FIG. 11 shows a block diagram of a method for re-training a neural network algorithm according to the disclosure;

FIG. 12 shows a block diagram of a method of performing a confidence analysis according to this disclosure;

FIG. 13 shows a graph of a comparison curve generated for the interfered peak of FIG. 8 as part of a confidence analysis; and

FIG. 14 shows a graph of a comparison curve generated for an interfered peak as part of a confidence analysis where the degree of confidence in the predicted curve is relatively low.

### DETAILED DESCRIPTION

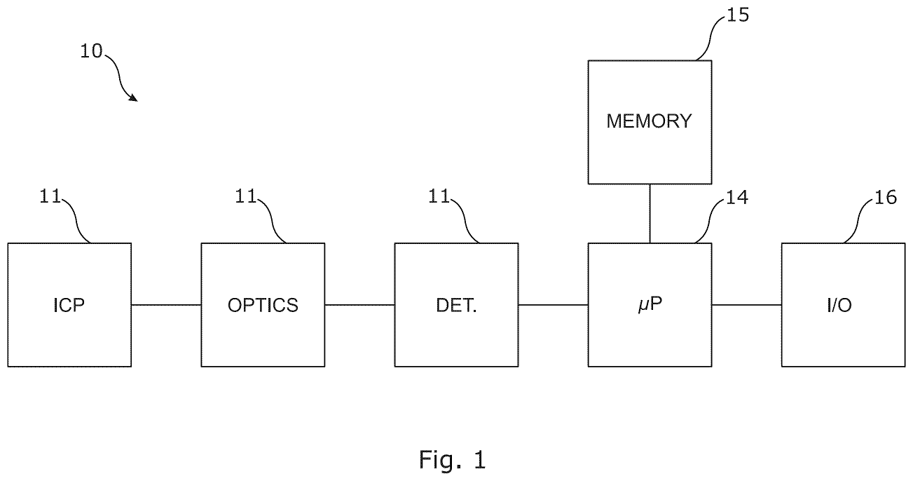

According to an embodiment of the disclosure, a spectrometry system 10 is provided. The spectrometry system 10 is configured to perform a method of spectrometry on a sample in order to generate a sample spectrum. The spectrometry system 10 may also process a sample peak in the sample spectrum according to a method of this disclosure. A schematic diagram of the spectrometry system 10 is shown in FIG. 1. As shown in FIG. 1, the spectrometry system 10 comprises an excitation source 11, an optical arrangement 12, a detector 13, a processor (μP) 14, a memory 15, and an input/output (I/O) unit 16. The spectrometry system 10 of FIG. 1 may be an optical emission spectrometry system, but the embodiments disclosed herein may be applied to any suitable spectrometry system, such as an x-ray fluorescence spectrometry system, a laser-induced breakdown spectrometry system, or any other suitable spectrometry system (with elements of the spectrometry system 10 being provided by analogous elements for other types of spectrometry systems, as known in the art).

In the embodiment of FIG. 1, the excitation source 11 is a plasma source, such as an inductively coupled plasma (ICP) source. In other embodiments, the excitation source 11 may be a furnace or any other high energy electromagnetic source which generates excited species suitable for use in spectrometry. The excitation source 11 may also be configured to receive a sample to be analysed using the spectrometry system 10. For example, where the excitation source 11 is a plasma source, a sample may be introduced into the plasma wherein the sample interacts with the plasma. Samples in aqueous form may be introduced directly into the plasma source, while solid samples may be introduced using laser ablation or vaporisation, for example.

In the embodiment of FIG. 1, the optical arrangement 12 may comprise an echelle grating and a prism (and/or a further grating) to produce a two-dimensional image of the light produced by the excitation source 11 (and sample if present). The two-dimensional image is formed on the detector 13. In such an arrangement, the optical arrangement 12 may be configured to direct radiation from the excitation source 11 to the detector such that the radiation is suitable for detection by the detector 13. The full area of the detector 13 that may return radiation information to the processor 14 may be referred to as the “fullframe.”

In the embodiment of FIG. 1, the detector 13 may be a CCD (charge-coupled device) array. A typical CCD array may have at least approximately 1024×1024 pixels (i.e., 1 Megapixel). In other embodiments, the detector 13 may be a complementary metal-oxide semiconductor (CMOS) or a charge injection device (CID) detector. The CCD array (or other detector 13) may be configured to produce a spectrum intensity value for each pixel of the detector 13 representative of the intensity of the light incident on the pixel. The detector 13 is configured to transfer the photon intensity values to the processor 14. As such, the detector 13 may be a multichannel detector that is configured to detect a plurality of different wavelengths. The detector 13 (such as in the embodiment of FIG. 1) may be configured to detect a two-dimensional spectrum. The detector 13 is configured to output the recorded intensity of each pixel of the detector 13 to the processor 14 for further analysis.

The processor 14 (controller) may comprise one or more commercially available microprocessors or any other suitable processing devices. The memory 15 can be a suitable semiconductor memory and may be used to store instructions allowing the processor 14 to carry out an embodiment of the method according to this disclosure. The processor 14 and memory 15 may be configured to control the spectrometry system 10 to perform methods according to embodiments of this disclosure. As such, the memory 15 may comprise instructions which, when executed by the processor 14, cause the spectrometry system 10 to carry out methods according to embodiments of this disclosure.

The spectrometry system 10 may be configured to generate a sample spectrum by introducing the sample to the excitation source 11. The excitation source 11 interacts with the sample wherein spectral emissions that are characteristic of the sample are emitted by the sample. The spectral emissions from the excitation source 11 and the sample are directed by the optical arrangement 12 to the detector 13. The echelle grating of the optical arrangement 12 diffracts the spectral emissions of different wavelengths by varying amounts such that peaks associated with the different spectral emissions are detected at different locations on the detector 13. As such, the location of a spectral emission on the detector 13, or a pixel number (x) representative of a detector location on which a spectral emission is incident, can be converted to wavelength based on a known relationship between detector location/pixel number and wavelength for the spectrometry system 10. Accordingly, spectrometry systems 10 according to this disclosure may refer to a wavelength of an interfered peak interchangeably with a detector location or pixel number of a detector 13.

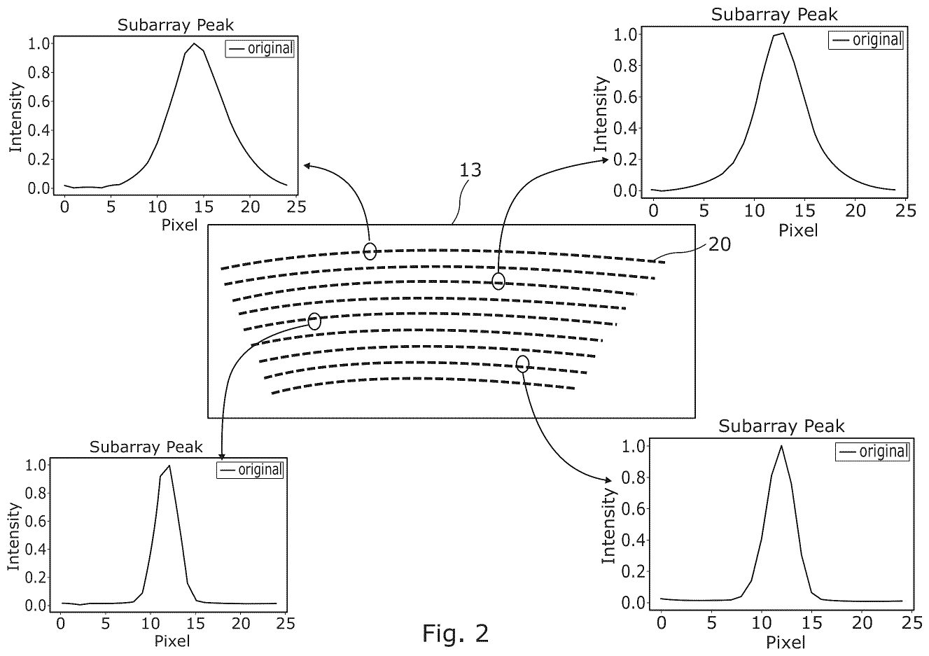

FIG. 2 shows a schematic diagram of the two-dimensional detector 13 of the embodiment of FIG. 1. The two-dimensional detector 13 of FIG. 2 is formed from an array of pixels, although each pixel is not individually represented in FIG. 2. FIG. 2 includes schematic representations (dashed lines) of the orders of light 20 diffracted by the echelle grating and prism and imaged on the detector 13. Each order 20 corresponds to a different wavelength range, and the wavelength varies in the transverse direction along each order. For example, in the embodiment of FIG. 2, the wavelength of the light may increase along each order from left to right. The starting wavelength of each order (left side) may also increase from order a) up to order i). FIG. 2 also shows four detailed views of example single spectral emissions that are imaged by groups of pixels of the detector at different locations on the detector 13. It will be appreciated that the peak shape of each of the spectral emissions differs based, at least in part, on the optical aberration of the optical arrangement 12.

Each spectral emission which is incident on the detector 13 may be detected as a peak which is incident across a plurality of pixels of the detector 13. The shape of the peak associated with spectral emission will depend, at least in part, on the optical arrangement 12 used to diffract and focus the spectral emission on the detector 13. For example, where the optical arrangement 12 comprises an echelle grating, the optical aberration introduced by the echelle grating will vary depending on the location on the detector 13 where the spectral emission is directed. As such, the shape of a peak measured by the spectrometry system 10 may depend on the detector location (representative of wavelength) of the peak. It will be appreciated that for some optical arrangements 12, the same wavelength may be diffracted to a plurality of locations on the detector 13. As such, while a detector location may be associated with a wavelength, a wavelength of a peak may be associated with a plurality of detector locations.

Where two spectral emissions have a similar wavelength, the peak associated with each spectral emission may be directed to a similar region of the detector. Where two spectral emissions are directed to a similar region of the detector such that at least a portion of one peak overlaps with another peak, the individual peaks can be challenging to resolve individually. These peaks are known as interfered peaks. In particular, the peaks can be challenging to resolve due to the variable optical aberration introduced by the optical arrangement, which can cause the peak shapes of individual spectral emissions to vary across a detector/with wavelength.

Accordingly, the spectrometry system 10 according to this disclosure provides a method of analysing an interfered peak of a sample spectrum in order to resolve the different spectral emissions forming the interfered peak.

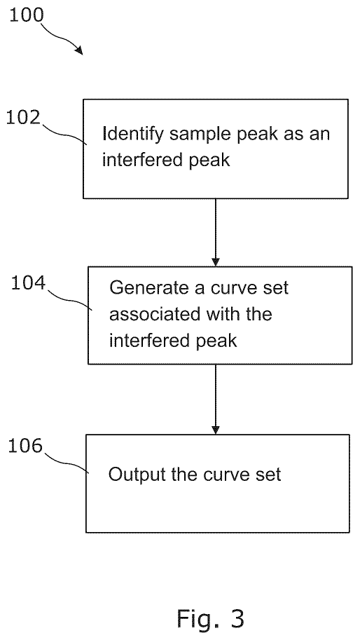

Next, a method 100 of analysing a spectral peak of a sample spectrum will be described with reference to FIG. 3. FIG. 3 shows a block diagram of the method 100. The method 100 may be performed by the processor of the spectrometry system 10. Alternatively, the method 100 may be performed by any other processor that is provided with the sample spectrum generated by the spectrometry system 10.

In step 102 of the method 100, the processor 14 identifies if a sample peak of the sample spectrum is an interfered peak. The sample spectrum may comprise a plurality of peaks generated from spectral emissions of the spectrometry system 10. Interfered peaks are the result of two or more spectral emissions falling incident on the same region of the detector such that they overlap. That is to say, the peaks from two or more spectral emissions may be in close proximity on the detector (e.g., within about 20 pixels of each other in some spectrometry systems 10) such that at least a portion of the peak associated with each spectral emission overlaps with one or more other peaks of other spectral emissions.

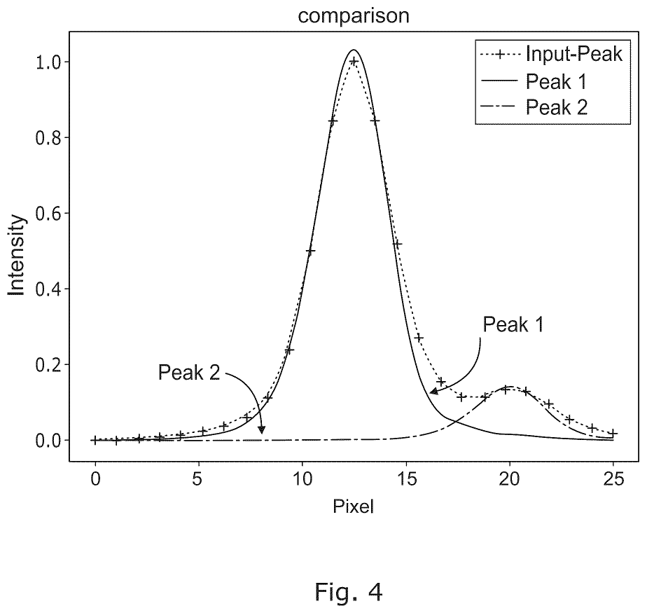

FIG. 4 shows an example of an interfered peak that may be processed according to embodiments of the disclosure. FIG. 4 shows an example of an interfered peak resulting from two spectral emissions of different wavelengths. In the example of FIG. 4, the peaks of the two spectral emissions are within 20 pixels of each other. Thus, the two spectral emissions will overlap.

In method 100, the interfered peak shown in FIG. 4 may be distinguished from other peaks in the sample spectrum by analysing the first derivative of the sample spectrum. Sample peaks of the sample spectrum resulting from a single spectral emission may be distinguished from interfered peaks based on, for example, the number of zero-crossings of the first derivative within a specified wavelength range of the wavelength corresponding to the maximum intensity of the peak (e.g., ±10 pixels from the peak intensity pixel of the sample peak). Based on the number of zero-crossings of the first derivative present, the method may determine the number of different spectral emissions forming the interfered peak. For each different spectral emission present in the interfered peak, the method 100 attempts to generate a curve representative of the spectral emission. As such, if the first derivative of the sample spectrum indicates that two different spectral emissions are present in the interfered peak (as in FIG. 4), the method 100 will subsequently generate a curve set including two curves, each associated with a different one of the spectral emissions in the interfered peak.

If an interfered peak is identified at step 102, the method 100 moves on to step 104 a curve set associated with the interfered peak is generated. In order to generate a curve set associated with an interfered peak, a neural network is used to output a peak shape for each spectral emission forming part of the interfered peak. In the example of FIG. 4, the neural network outputs the shape of two peaks to be fitted to the interfered peak.

It will be appreciated that the method of FIG. 3 relies upon a neural network technique to process the interfered peak. Prior to discussing step 104, in which the neural network technique is used to predict peak shapes in detail, the process for training the neural network used in the neural network technique will be discussed.

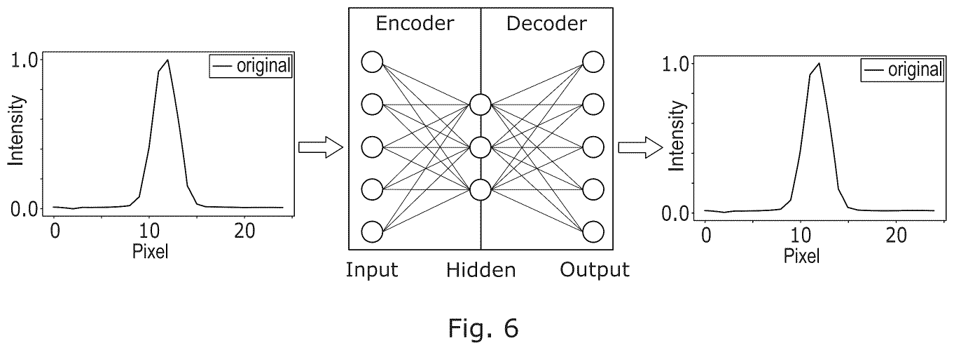

As discussed above, the neural network may be trained to output a peak shape based on data representative of the peak wavelength of a spectral emission (and, in some embodiments, peak intensity of the spectral emission). The peak shape output by the neural network may be an encoded peak shape, indicating a peak shape by a fixed number of parameters. The particular encoding output by the neural network may be one generated by an autoencoder trained on the training data set. A diagram of an autoencoder is given in FIG. 6. The autoencoder may include an encoder and a decoder, with the encoder receiving, as input, a non-interfered peak, and outputting a lower-dimensional, encoded representation of the shape of that peak. With reference to FIG. 6, the number of hidden nodes in the autoencoder corresponds to the number of parameters used in the encoded representation of the input peak (e.g., three parameters in FIG. 6). The decoder may receive, as input, a number of parameters corresponding to number of hidden nodes, and may output a peak having the same dimensionality as the input to the encoder. The training peaks in the training data set may be normalized (e.g., scaled so that the maximum value of the training peaks are all equal to a same constant value, such as 1) to ensure that the autoencoder training focuses on peak shape and to avoid the autoencoder improperly making inferences relating to intensity (since the intensity information in a sample spectrum is relevant to the properties of the underlying sample). The autoencoder (which itself takes the form of a neural network, as known in the art) may be trained using techniques known in the art to reduce the dimensionality of the input peak to the number of nodes in the hidden layer and then use the reduced dimensionality information to reconstruct the peak. In some embodiments, the autoencoder may be iteratively trained with successively fewer numbers of hidden nodes and the resulting encoding/decoding performance assessed; the smallest hidden layer (corresponding to the number of parameters in the encoding) may be selected that achieves a desired level of performance (e.g., a desired accuracy in encoding/decoding). In some embodiments, the autoencoder may be a linear autoencoder.

For training the neural network that will output peak shape information, a training peak may be provided to the trained encoder, and the output of the trained encoder may be a shape parameter vector (having a number of elements equal to the number of hidden nodes). As such, each training peak may be reduced to a shape parameter vector comprising a selected number of shape parameters (e.g., three shape parameters (p1, p2, p3) in the embodiment of FIG. 6); the training peak can be reconstructed by providing this shape parameter vector to the trained decoder. Of course, in other embodiments, the nature of the optical aberration of the specific spectrometry system 10 may result in a shape parameter vector having a different number of parameters.

The neural network may then be trained on the shape parameter vectors representing the training peaks. In particular, the neural network may be trained on input-output pairs in which the input is data representative of the peak wavelength of a training peak (e.g., a detector location) and the output is the shape parameter vector of the training peak. When many training peaks associated with many different peak wavelengths across the detector 13 are used to train the neural network, the neural network may learn to predict the peak shape for a peak (the shape parameter vector) based on data representative of the peak wavelength (e.g., an input detector location/pixel number).

As discussed above, each training peak may be generated from a single spectral emission, wherein each of the plurality of training peaks has a different wavelength. The plurality of training peaks is taken from a range of different locations on the detector 13 (e.g., as illustrated in FIG. 2). In some embodiments, the plurality of training peaks is generated by the spectrometry system 10 using one or more calibration samples. In some embodiments, a calibration sample may be a single-element solution (i.e., a solution including a single element). Some such single-element solutions result in the detector 13 generating a calibration spectrum comprising a plurality of sparsely distributed individual peaks, and a collection of such spectra may provide good coverage of the wavelengths detectable by the detector 13. In some embodiments, one or more of the single-element solutions used for calibration include a single element selected from the transition metals. Transition metals, when used for spectrometry, produce a plurality of well-defined, well-distributed individual peaks that are well-suited for characterising the optical aberration of the spectrometry system 10 across the detector 13.

Accordingly, the neural network may be trained as discussed above and then deployed to generate a peak shape (e.g., in the form of a vector of shape parameters, such as the vector (p1, p2, p3) discussed above with reference to FIG. 6) for any detector location of interest. The neural network technique performed at step 104 of the method 100 may include using the trained decoder to decode the shape parameters describing the peak shape to generate a decoded peak shape that is representative of a spectral emission at a specified detector location. Thus, a neural network technique may be trained, and subsequently used, to predict peak shapes for the purpose of analysing interfered peaks.

The method to be performed at step 104 of FIG. 3 will now be discussed. As discussed above, at step 104, a curve set associated with the interfered peak is generated. In order to generate the curve set, the neural network technique predicts the peak shape for each spectral emission forming part of the interfered peak based on data representative of an initial wavelength (e.g., a detector location) for each spectral emission and an intensity associated with each of the spectral emissions. In the example of FIG. 34, the neural network generates two curves to be fitted to the interfered peak.

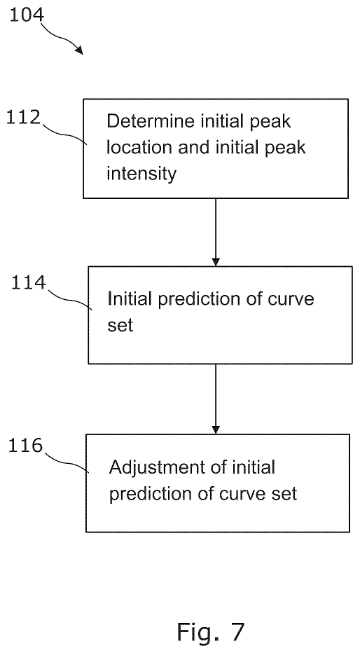

FIG. 7 shows a further block diagram explaining an example set of steps taken in step 104 generate a curve set for an interfered peak.

In order to predict the shape of the peaks, the neural network is provided with an initial peak location (xₙ) of one or more spectral emissions incident on the detector (equivalent to wavelength, as discussed above) and an initial peak intensity (aₙ) for each spectral emissions of the N spectral emissions in an interfered peak. Accordingly, in step 112, the processor 14 processes the interfered peak to determine the initial peak location (xₙ) and the initial peak intensity (aₙ) (where n=1, 2, . . . N) (e.g., using the first-derivative technique discussed above, or any other suitable technique). Note that, although a single variable name (x) is given for the peak location, a peak location may be specified by a two-dimensional parameter (e.g., x- and y-pixels in a two-dimensional pixel arrangement for a detector).

As such, in step 112, the processor 14 assembles the initial parameters (x₁, a₁; x₂, a₂; . . . x_{N}, a_{N}) for the N peaks associated with the interfered peak. In the example of FIG. 4, there are two curves (N=2) to be fitted to the interfered peak, with associated parameters (x₁, a₁; x₂, a₂).

In the example of FIG. 4, the interfered peak data recorded by the detector 13 is shown in dashed lines. In FIG. 4, the data is presented using pixel number rather than wavelength on the horizontal axis of FIG. 4. Based on this data from the detector 13, the processor 14 determines that there is a first curve having a first peak location (x₁) equal to approximately 12 and a first initial peak intensity (a₁) equal to approximately 1.0, and a second curve having a second initial peak location (x₂) equal to approximately 21 and a second peak intensity (a₂) approximately equal to 0.1.

Based on the initial peak location (x) and the initial peak intensity (a), in step 114 the processor 14 outputs an initial identification of the curves using the neural network. As discussed above, the neural network algorithm is configured to output shape parameters (e.g., (pₙ₁, pₙ₂, pₙ₃) for a three-dimensional encoded shape representation) for each of the N curves to be output. The decoder may then be used to decode the shape parameters to provide an initial identification of the curves forming the interfered peak.

In some embodiments, peak intensity may not be provided to the neural network as an input, but may instead be applied to the output of the neural network (e.g., by scaling) to ensure that the curves in the resulting curve set have the correct peak intensities.

For example, in FIG. 4, the solid lines for peak 1 and peak 2 show the two initially output curves. The two curves are decoded from the shape parameters output by the neural network algorithm.

To further improve the fit of the fitted curves, in step 116 the processor 14 may further adjust the initially output curves. For example, the operations at step 116 may include shifting the locations of peaks (e.g., their associated peak wavelengths) to try to minimize the root-mean-square error (RMSE) between the summed curves and the measures sample spectrum. It will be appreciated that the adjustment step 116 is optional. As such, in some embodiments, the initially output curve set may be suitable for use in further analysis. Thus, in some embodiments the method may proceed directly from step 114 to step 106 of method 100.

Returning to the method 100 of FIG. 3, at step 106, the curves associated with each spectral emission in an interfered peak may be output for further analysis. Step 106 can include any of a number of operations. In some embodiments, the peak which is closest in location to its factory-calibrated position may be automatically selected, and only its location and intensity may be used to generate a single, un-interfered peak. In some embodiments, the processor 14 may cause the curves to be displayed on a display device, and a user may be prompted to choose among multiple curves associated with an interfered peak. The user may, for example, select only the curve that represents an analyte of interest, and use its location and intensity to generate a single, un-interfered peak. In some embodiments, peaks deemed to be interferences (e.g., by identifying those farthest in location from their factory-calibrated positions) from the pixel intensities of the peak associated with the analyte of interest to generate a single, un-interfered peak.

As an alternative to predicting a peak shape for an analyte of interest directly using the neural network, in some embodiments the processor 14 may predict the peak shapes for peaks which are interfering with a peak associated with an analyte of interest. The predicted peak shapes for the interfering peaks may then be subtracted from the original signal in order to determine a peak shape associated with the analyte of interest. That is to say, where an interfered peak is detected comprising e.g. three spectral emissions, two predicted peak shapes (associated with interfering peaks) may be subtracted from the interfered peak to leave only a single peak associated with the analyte of interest.

In some embodiments, the method 100 may be used to generate a curve for a spectral emission of an interfered peak. The generated curve may be used to improve a background correction method for the spectral emission as discussed further below.

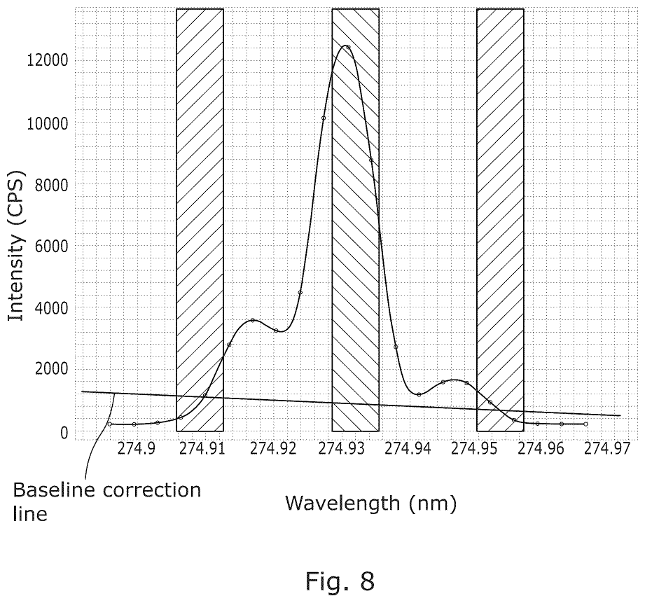

FIG. 8 shows a further graph of an interfered peak generated by a spectrometry system 10. FIG. 8 shows the intensity (Counts Per Second CPS) detected by the pixels of an array detector. In the graph of FIG. 8 the detector locations for each pixel have been converted to the associated wavelength (in nm). The interfered peak of FIG. 8 includes three distinct peaks, indicative of at least three spectral emissions in close proximity to each other on the detector. Attempts to perform a baseline correction in order to analyse the central peak of FIG. 8 result in inaccuracies. As shown in FIG. 8, the interferences from the neighbouring spectral emissions distort the baseline correction line shown in FIG. 8. Consequently, subsequent analysis of the central peak of the interfered peak is likely to be inaccurate due to interference from neighbouring spectral emissions. In such cases, a user would often disregard the interfered peak, due to low confidence in the accuracy of the baseline correction.

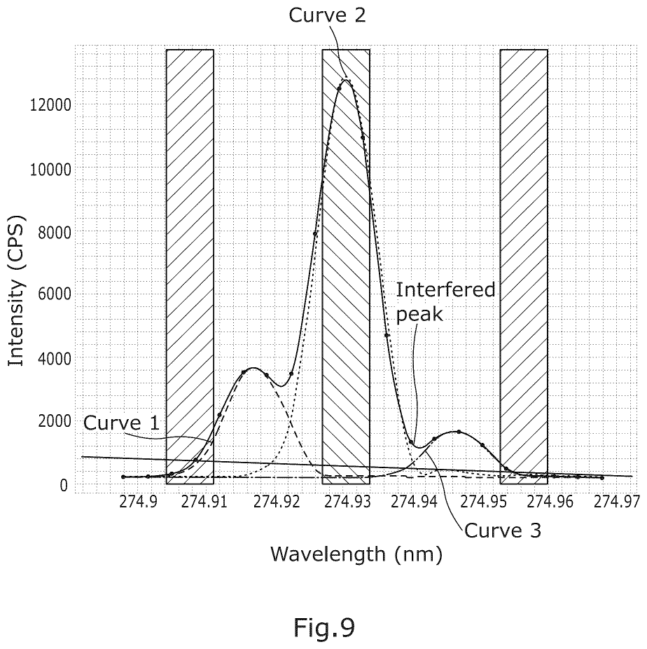

According to methods of this disclosure 100, the interfered peak may be analysed in order to generate a curve set comprising three curves (Curve 1, Curve 2, Curve 3). FIG. 9 shows a graph of the curve set generated overlaid on the interfered peak of FIG. 8. Generation of the curves for each of the three most prominent spectral emissions in the interfered peak allows for each of the spectral emissions to be analysed individually (i.e. without interference from neighbouring spectral emissions in the interfered peak).

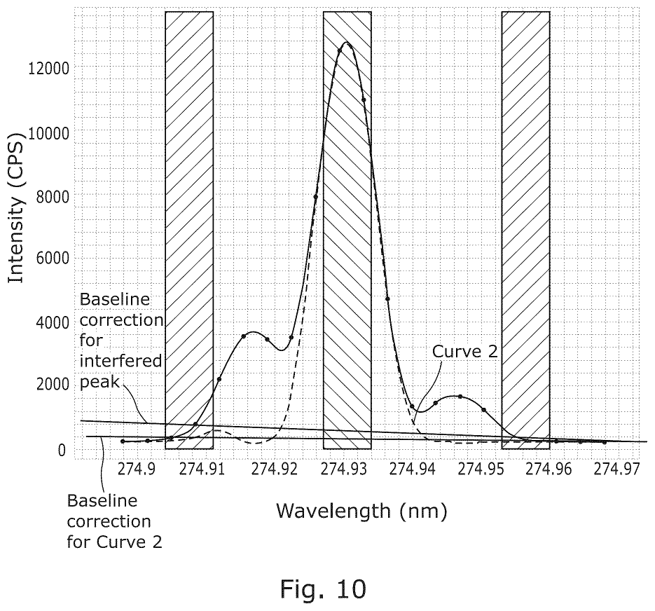

FIG. 10 shows a graph of Curve 2 overlaid on the interfered peak of FIG. 8. Using Curve 2, an improved baseline correction may be performed in order to analyse the central spectral emission of the interfered peak. As shown in FIG. 10, the improved baseline correction is not distorted by the other spectral emissions of the interfered peak. Consequently, Curve 2 can be used to analyse the intensity of the associated spectral emission (i.e. the area under Curve 2) with improved accuracy.

In some embodiments, the neural network technique may not include an initial encoding of the peak shapes, but instead may be structured to expect a class of possible mathematical distributions that may describe the observed peaks (e.g., Gaussian, Lorentzian, Bi-Gaussian, Gaussian plus Lorentzian, Lorentzian plus Gaussian, etc.) using techniques known in the art (e.g., selection of appropriate loss functions), and the neural network is free to infer the most appropriate ones during training. Additionally, in some embodiments, the neural network may itself perform the encoding of the peak shapes; for example, the neural network, via appropriate selection of an error function, may perform an encoding such that a parameter that shows the highest rate of change with location is selected as an encoding parameter.

Thus, it will be appreciated that a neural network technique may be used to generate peak shapes for individual spectral emissions forming part of an interfered peak. Accordingly, the neural network-based analysis method according to this disclosure may be used to determine information about individual spectral emissions forming part of an interfered peak. For example, information regarding the wavelength and intensity of different spectral emissions forming part of an interfered peak may be determined according to embodiments of this disclosure. This information (peak wavelength, peak intensity) may then be used to assist with identification and analysis of the sample.

In some embodiments, the neural network may be retrained during operation of the spectrometry system 10 after further training data has been generated and/or after corrections have been received from a user. For example, in some embodiments, the processor 14 may cause a display to request that the user mark regions of the fullframe (which may include some or all of the fullframe) in which the user wishes the peak shapes to be retrained (e.g., because the user is not satisfied with current performance).

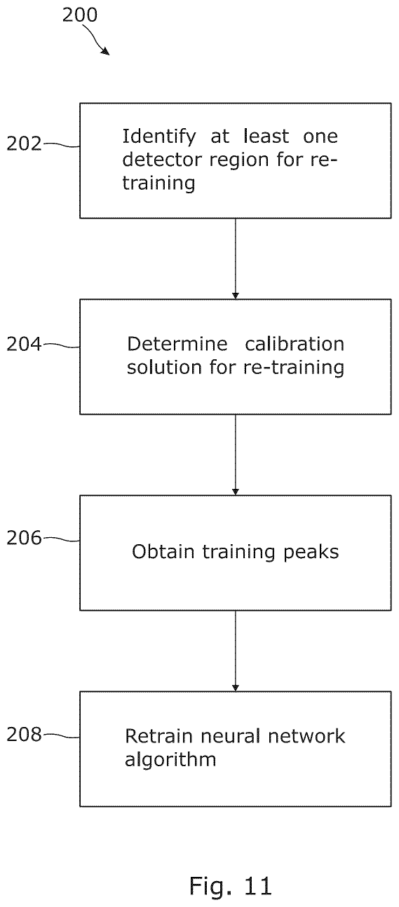

FIG. 11 shows a block diagram of a method 200 for retraining a neural network algorithm according to this disclosure. As shown in step 202 of FIG. 11, the method comprises identifying at least one detector region for retraining. Where the detector is an array detector, a region of the detector may be, for example, one or more orders of the detector. Alternatively, a region of the detector may be defined as an area of the detector, for example a square or rectangular region of the detector. In some embodiments, a region of the detector may comprise an area extending in at least one direction (e.g. along an order) of at least: 20 pixels, 30 pixels, 50 pixels, 70 pixels or 100 pixels. Alternatively a user may specify a region of the fullframe of the detector 13 for retraining. The user may perform the identification step manually, or the processor may be configured to identify regions of the detector 13 for retraining.

Once one or more regions of the detector are identified for retraining, the processor may then determine a calibration sample to be used in the retraining process. For example, the processor 14 may then output a recommendation to the user (based on the most probable/most intense emissions falling in the selected region) of one or more calibration solutions to be prepared. Preferably, one or more of the calibration solutions are single-element standard solutions thereby avoiding inter-element interferences. The recommended calibration solutions are selected by the processor based on knowledge that the elements in the calibration solutions have non-interfered peaks in the desired detector areas identified previous. The processor may determine the calibration solutions by reference to a database of known spectral peaks for single element calibration solutions.

Once the user has these solutions ready, further training peaks may be obtained by the spectrometry system 10 in step 206. For example, the processor 14 may instruct the user on how to use the spectrometry system 10 to acquire spectra comprising the desired training peaks. The processor 14 may then request that the user review the spectra and check that the training peaks are not interfered by other peaks, or to otherwise mark training peaks as “interfered” or “not interfered.”

In step 208, the processor 14 may then perform the retraining of the neural network algorithm using the further training peaks. The processor 14 may then take the peaks selected as “not interfered” by the user and pre-process them by scaling their intensities and providing them to the encoder to produce an encoded representation of their shapes, as discussed above. The encoded representation of each further training peak, along with its peak location, will be used to retrain the neural network to improve the ability of the neural network to map peak location to peak shape. The resulting retrained model will be stored in a memory device (e.g., on the user's premises or in the cloud) and used for subsequent spectra.

As discussed above, it will be appreciated that a peak shape (curve) associated with a spectral emission may be obtained by directly predicting the curve from the interfered peak using the neural network. Alternatively, the peak shape associated with a spectral emission may be obtained by predicting curves for the other spectral emissions of the interfered peak and subtracting the predicted curves from the interfered peak.

In principle, the two methods of obtaining a peak shape for an analyte of interest should arrive at peak shapes which have a high degree of similarity. Where the two methods result in different peak shapes, such differences may indicate that further investigation is required. As such, comparing the curves generated by the two methods may provide an initial indication of that the predicted curves are an accurate reflection of the spectral emissions forming the interfered peak (i.e. a degree of confidence that the predicted curves are accurate). As such, in some embodiments, the method 100 may involve performing a confidence analysis 120 on the curve set obtained in step 104. The confidence analysis may be performed on the initial predictions of the curve set (see step 114) or on the adjusted curves output following step 116 of FIG. 7. The confidence analysis may be used to indicate whether one or more curves in a curve set has been predicted with a relatively high degree of confidence or a relatively low degree of confidence.

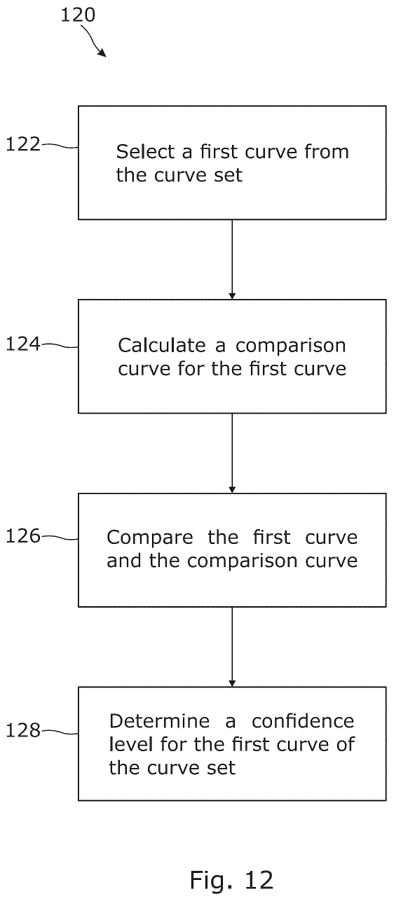

FIG. 12 shows a block diagram of a method of performing a confidence analysis 120 according to this disclosure. The confidence analysis 120 may be performed on a curve set generated for an interfered peak according to this disclosure. The confidence analysis 120 of FIG. 12 comprises a step 122 of selecting a first curve from the curve set. For example, the first curve may be the curve associated with the highest intensity spectral emission may be selected. In step 124 the confidence analysis 120 may then calculate a comparison curve for the first curve by subtracting the other curves in the curve set from the interfered peak (i.e. the original signal). In step 126 the confidence analysis may then compare the first curve to the comparison curve and subsequently in step 128 determine a confidence level for the first curve associated with the curve set.

For example, in step 126 the confidence analysis 120 may compare the first curve to the comparison curve by evaluating the difference between the two curves. Suitable algorithms for comprising the first curve and the comparison curve include root mean squared error, mean absolute error, Fréchet distance etc. Other algorithms suitable for numerically evaluating the difference(s) between two curves may also be used.

In some embodiments, the comparison of step 126 may generate a numerical value generated (e.g. root mean squared error). In step 128, the determined confidence level may be the numerical value calculated in step 126. In some embodiments, the numerical value may be scaled in order present the numerical value on a more user-friendly scale as a confidence value. In some embodiments, the numerical value may be compared to one or more predetermined thresholds, with a different confidence level assigned to different ranges for the numerical value. For example, in one embodiment the numerical value may be compared to a confidence threshold, wherein for root mean squared errors (or any other suitable algorithm and associated numerical values) no greater than the confidence threshold, a first confidence value may be assigned to the curve set indicating that the first curve and comparison curve are sufficiently similar. For root mean squared errors above the confidence threshold, a second confidence value may be assigned to the curve set indicating that the first curve and comparison curve have a relatively high degree of difference which could be further investigated.

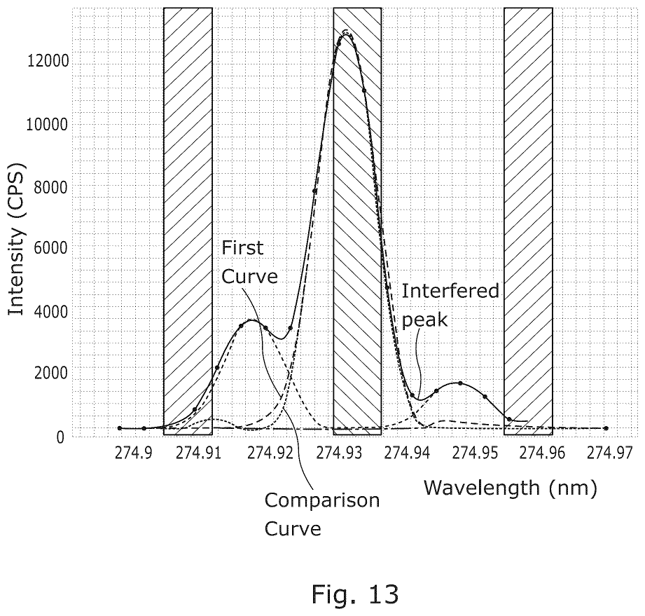

As an example, FIG. 13 shows a further graph of the interfered peak and curve set of FIGS. 8 and 9, where a confidence analysis has been performed. As shown in FIG. 13, Curve 2 of FIG. 8 has been selected as a first curve and a comparison curve has been generated by subtracting Curves 1 and 3 from the interference peak. It will be appreciated that the comparison curve and the first curve (Curve 2) have a relatively high degree of similarity, indicating a high degree of confidence that the curve set has accounted for background emissions and all spectral emissions in the interfered peak.

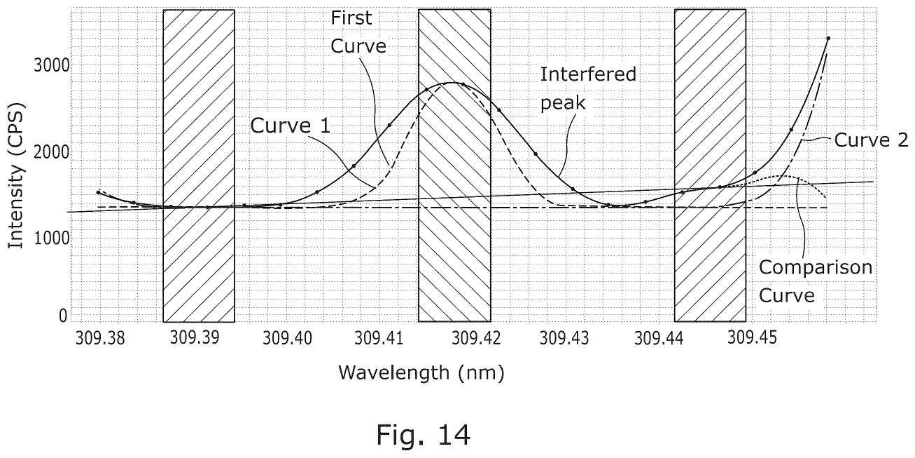

By contrast, FIG. 14 shows a graph of a curve set generated for another interfered peak. In the example of FIG. 14, the neural network has generated two curves (Curve 1, Curve 2) for the interfered peak. Performing a confidence analysis using Curve 1 as the first curve indicates there is a relatively large difference between the first curve and the comparison curve (the comparison curve substantially overlaps with the interfered peak across the wavelength range 309.38 to 309.44 nm in FIG. 14). Thus, FIG. 14 is an example where root mean squared error of the difference between the first curve and the comparison curve may exceed a first threshold, thereby indicating there is a relatively low degree of confidence in the predicted curve set. Thus, the confidence analysis may output a signal to a user that the predicted curve (Curve 1) has a relatively low degree of confidence associated with it.

Accordingly, the spectrometry system 10 and methods according to this disclosure allow a user to analyse interfered peaks generated by a spectrometry system 10. In particular, a curve set may be generated which is associated with one or more of the spectral emissions forming the interfered peak, allowing said spectral emissions to be further analysed.

1. A method of operating a spectrometer controller, comprising:
obtaining an interfered peak using a detector of a spectrometer, wherein the interfered peak is produced by a plurality of spectral emissions of different wavelengths, each of the plurality of spectral emissions in the interfered peak incident on the detector at an associated detector location;
for one or more of the spectral emissions of the interfered peak, generating an associated curve using a neural network, wherein the neural network is trained to output data indicative of a shape of the associated curve based on data representative of the associated detector location; and
for one or more of the spectral emissions of the interfered peak, outputting the associated curve.

2. A method according to claim 1, wherein
the neural network is to output an encoded representation of a shape of the associated curve; and
generating an associated curve includes decoding the encoded representation.

3. A method according to claim 1, further comprising:
training the neural network based on a plurality of training peaks, wherein each training peak is a single spectral emission of associated with a different detector location generated by the spectrometer.

4. A method according to claim 3, wherein:
training is initiated for a detector region based on a user indication of the detector region to be trained.

5. A method according to claim 3, wherein:
the training peaks are associated with one or more single-element solutions.

6. A method according to claim 5, wherein
an individual one of the single-element solutions is a transition metal solution.

7. A method according to claim 3, further comprising:
obtaining further training peaks generated by the spectrometer for a detector region of the detector; and
repeating the training of the neural network based on the further training peaks.

8. A method according to claim 7, further comprising
identifying a calibration sample to be used to obtain the further training peaks.

9. A method according to claim 1, further comprising:
after causing a display device to output the associated curve includes receiving a user selection of the associated curve for use in subsequent analysis.

10. A method according to claim 1, wherein:
the spectrometer comprises an echelle grating and a two-dimensional array detector, wherein the spectrometer generates a sample spectrum using the echelle grating to diffract light on to the two-dimensional detector.

11. A method according to claim 1, further comprising:
identifying a sample peak as an interfered peak.

12. A method according to claim 11, wherein
identifying the sample peak as an interfered peak comprises calculating a first derivative of the sample peak, wherein the sample peak is determined to be an interfered peak based on a number of zero-crossings of the first derivative of the sample peak.

13. A method according to claim 12, wherein
the associated detector location of each spectral emission in the interfered peak is determined based on the zero-crossings of the first derivative of the sample peak.

14. A method according to claim 1, wherein
the spectrometer controller causes a display device to output the associated curve.

15. A method according to claim 1, wherein
the spectrometer controller calculates a concentration of an element based on an area under the associated curve.

16. A method according tom claim 1, wherein,
the spectrometer is an optical emission spectrometer, and the spectrometer controller is an optical emission spectrometer controller.

17. A method according to claim 1, wherein
the detector of the spectrometer is an array detector.

18. A method according to claim 1, wherein
a curve is output for each of the spectral emissions in the interfered peak.

19. A method according to claim 18, wherein
a comparison curve associated with a spectral emission is obtained by subtracting the curves for the other spectral emissions of the interfered peak from the interfered peak.

20. A method according to claim 19, further comprising
comparing the comparison curve of the spectral emission to a curve output by the spectrometer controller for the same spectral emission; and
determining a confidence level for the curve output by the spectrometer controller based on the comparison.

21. A spectrometer controller for a spectrometer, the spectrometer controller configured to:
obtain an interfered peak using a detector of a spectrometer, wherein the interfered peak is produced by a plurality of spectral emissions of different wavelengths, each of the plurality of spectral emissions in the interfered peak incident on the detector at an associated detector location;
for one or more of the spectral emissions of the interfered peak, generate an associated curve using a neural network, wherein the neural network is trained to output data indicative of a shape of the associated curve based on data representative of the associated detector location; and
for one or more of the spectral emissions of the interfered peak, output the associated curve.

22. A spectrometry system comprising:
a spectrometer comprising a detector, the spectrometer configured to generate a sample spectrum from a sample using the detector;
a spectrometer controller configured to process the sample spectrum, the controller further configured to:
obtain an interfered peak from the sample spectrum using the detector of the spectrometer, wherein the interfered peak is produced by a plurality of spectral emissions of different wavelengths, each of the plurality of spectral emissions in the interfered peak incident on the detector at an associated detector location;
for one or more of the spectral emissions of the interfered peak, generate an associated curve using a neural network, wherein the neural network is trained to output data indicative of a shape of the associated curve based on data representative of the associated detector location; and
for one or more of the spectral emissions of the interfered peak, output the associated curve.

23. A spectrometry system according to claim 22, wherein
the spectrometer comprises an excitation source.

24. A computer-readable storage medium having stored thereon a computer program comprising instructions configured to, upon execution by one or more processing devices of the controller, cause a spectrometer controller to execute the steps of the method of claim 1.

25. (canceled)
